(19) United States
(12) Patent Application Publication
(10) Pub. No.: US 2015/0022929 A1
(43) Pub. Date: Jan. 22, 2015

(54) OVER-CURRENT PROTECTION DEVICE

(71) Applicants: Yi An SHA, New Taipei (TW); Chun Teng TSENG, Sanwan Township (TW); Yi Nuo CHEN, Taipei City (TW)

(72) Inventors: Yi An SHA, New Taipei (TW); Chun Teng TSENG, Sanwan Township (TW); Yi Nuo CHEN, Taipei City (TW)

(73) Assignee: POLYTRONICS TECHNOLOGY CORP., Hsinchu (TW)

(21) Appl. No.: 14/280,862

(22) Filed: May 19, 2014

(30) Foreign Application Priority Data
Jul. 22, 2013 (TW) 102126054

(51) Int. Cl. H02H 9/02

(52) U.S. Cl. CPC H02H 9/026
USPC 361/93.8

(57) ABSTRACT

An over-current protection apparatus applied to a secondary battery comprises a lead frame, an IC and a PTC device. The lead frame has a carrier portion and two end portions bending therefrom to form an accommodating space. The two end portions electrically connect to positive and negative electrodes of the secondary battery. The carrier portion comprises a plurality of blocks. The IC and PTC device are disposed on the carrier portion and received in the accommodating space and encapsulated by a cover. The PTC device comprises a first electrode and a second electrode, and the first electrode and the second electrode electrically connect to different blocks of the carrier portion.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present application relates to an over-current protection apparatus, and more particularly to an over-current protection apparatus applied to a secondary battery.

2. Description of Related Art Including Information Disclosed Under 37 CFR 1.97 and 37 CFR 1.98.

Because the resistance of conductive composite materials having positive temperature coefficient (PTC) characteristic is very sensitive to temperature variation, it can be used as the material for current sensing devices, and has been widely applied to over-current protection devices or circuit devices. The resistance of the PTC conductive composite material remains extremely low at normal temperature, so that the circuit or cell can operate normally. However, when an over-current or an over-temperature event occurs in the circuit or cell, the resistance instantaneously increases to a high resistance state (i.e., trip) to decrease the current.

Nowadays, the over-current protection to a secondary battery, e.g., lithium battery, of a mobile apparatus is to connect the protective circuit module (PCM) and the secondary battery in series, and the PCM is equipped with a PTC device for over-current protection. FIG. 1 shows a PCM 10 in which a PTC device 11 is disposed on a printed circuit board (PCB) 15. The PCM 10 is usually provided with various passive devices such as a resistor 13, an inductor 14 and an IC chip 12 that may contain a field-effect transistor. The PTC device 11 and IC chip 12 have certain heights, and the PCB 15 carrying the PTC device 11 and the IC chip 12 has a certain thickness; therefore the PCM 10 would be of an entire height in the range of 1.8 mm to 2.3 mm, or even more thick.

With the advancement of the mobile electronic apparatuses, IC and passive devices have been trending to occupy less space in order to increase battery life. Therefore, it is crucial to minimize the PCM space by structural design under the premise that device size and resistance of the PTC device do not increase and the hold current does not decrease.

### BRIEF SUMMARY OF THE INVENTION

The present application provides an over-current protection apparatus adapted to connect to positive and negative electrodes in series to protect the battery in an over-current event. The over-current protection apparatus contains a space for receiving IC, PTC and other passive devices, and therefore can effectively decrease the entire height thereof.

In accordance with an embodiment of the present application, an over-current protection apparatus applied to a secondary battery comprises a lead frame, at least one active or passive device and a PTC device. The lead frame has a carrier portion to form an accommodating space. The lead frame may further comprise two end portions bending from the carrier portion and electrically connecting to positive and negative electrodes of the secondary battery. The carrier portion comprises a plurality of blocks. The active or passive device and PTC device are disposed on the carrier portion and received in the accommodating space and encapsulated by a cover. The PTC device comprises a first electrode and a second electrode, and the first electrode and the second electrode electrically connect to different blocks of the carrier portion. The active device may be an IC, and the passive device may comprise, for example, a resistor and/or an inductor.

In an embodiment, the first electrode of the PTC device connects to the lead frame by wire bonding, and the second electrode is soldered onto the surface of the lead frame. The PTC device may comprise a PTC material layer, and the first electrode and the second electrode are disposed on upper and lower surfaces of the PTC material layer.

In an embodiment, the PTC device spans a gap of adjacent blocks of the lead frame, and the first electrode and the second electrode connects to the adjacent blocks by reflow soldering, e.g., surface mount technology.

In an embodiment, the PTC device may further comprise a resistive device of a sandwich structure having a first conductive layer, a second conductive layer and a PTC material layer laminated therebetween. The first electrode electrically connects to the first conductive layer, and the second electrode electrically connects to the second conductive layer.

In an embodiment, the first electrode comprises electrode layers disposed on upper and lower surfaces of the PTC device, and the electrode layers are connected by a conductive connecting member. The second electrode comprises electrode layers disposed on upper and lower surfaces of the PTC device, and the electrode layers are connected by another conductive connecting member.

In an embodiment, the electrode layer of the first electrode on the upper surface occupies over 50% in area of the upper surface of the PTC device, and the electrode layer of the second electrode layer on the lower surface occupies over 50% in area of the lower surface of the PTC device.

Compared to a traditional PCM using a circuit board as a substrate, the apparatus of the present application using a lead frame as a substrate can reduce the height or thickness of the apparatus in an amount of up to 50%, e.g., 1.5 mm, 1.2 mm, 1 mm or even thinner. The PTC device may be in the form of a surface-mount device spanning a gap of adjacent blocks, in which the first and second electrodes at left and right sides may connect to the adjacent blocks of the lead frame. As such, the length of the PTC device is not relatively restricted, and thus a larger PTC device in terms of large hold current and low resistance can be employed.

### BRIEF DESCRIPTION OF THE SEVERAL VIEWS OF THE DRAWINGS

The present application will be described according to the appended drawings in which:

FIG. 1 shows a known PCM;

FIGS. 2 to 4 show an over-current protection apparatus in accordance with a first embodiment of the present application;

FIG. 5 shows an over-current protection apparatus in accordance with a second embodiment of the present application;

FIG. 6 shows a PTC device of an over-current protection apparatus in accordance with a third embodiment of the present application; and

FIG. 7 shows a PTC device of an over-current protection apparatus in accordance with a fourth embodiment of the present application.

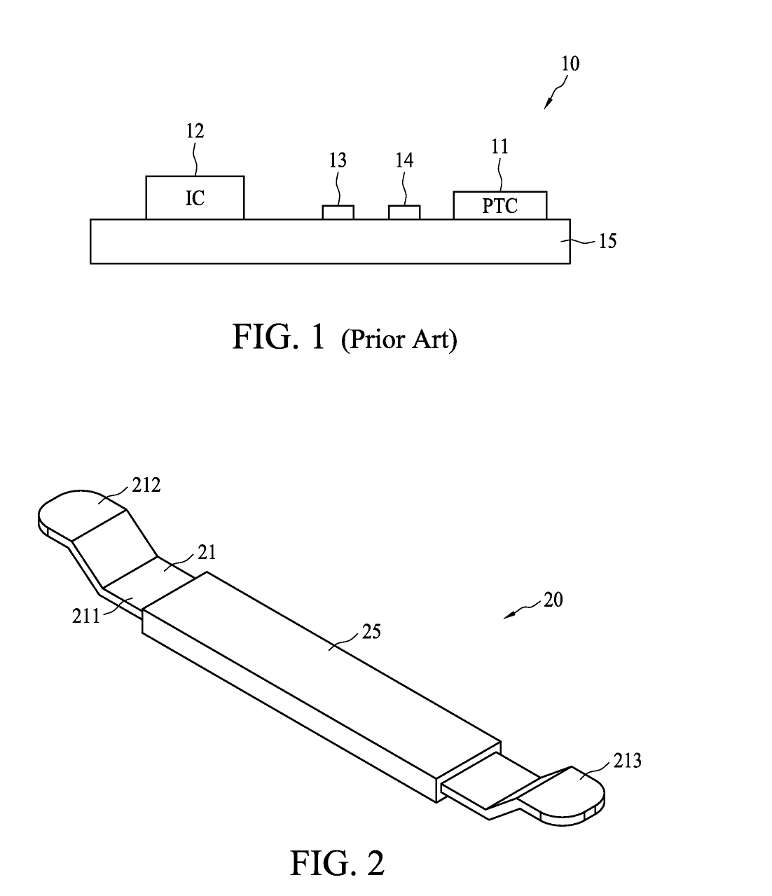

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

FIG. 2 shows a perspective view of an over-current protection apparatus for protection to a secondary battery in accordance with a first embodiment of the present application. An over-current protection apparatus 20 comprises a lead frame 21 as a substrate to support electronic components thereon, and the electronic components are wrapped and encapsulated by a cover 25. The lead frame 21 has a carrier portion 211 and two end portions 212 and 213 bending therefrom to form an accommodating space. The length, width and height of the accommodating space can be adjusted according to the electronic components, so as to receive various active and passive devices on the carrier portion 211. In assembly to protect a secondary battery, the over-current protection apparatus 20 turns over and the two end portions 212 and 213 electrically connect to a positive electrode and a negative electrode of the secondary battery, respectively.

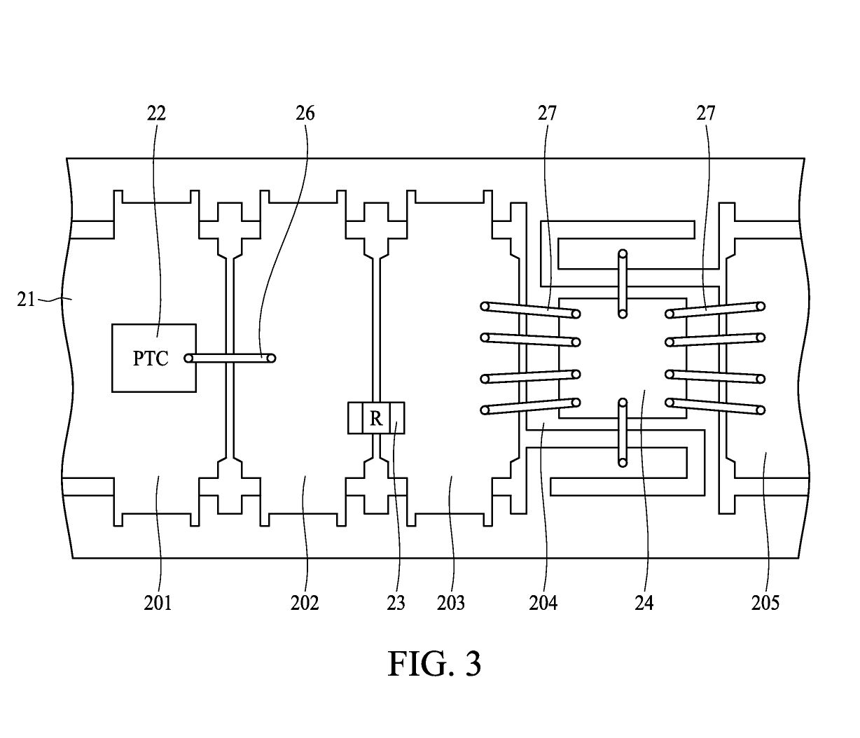

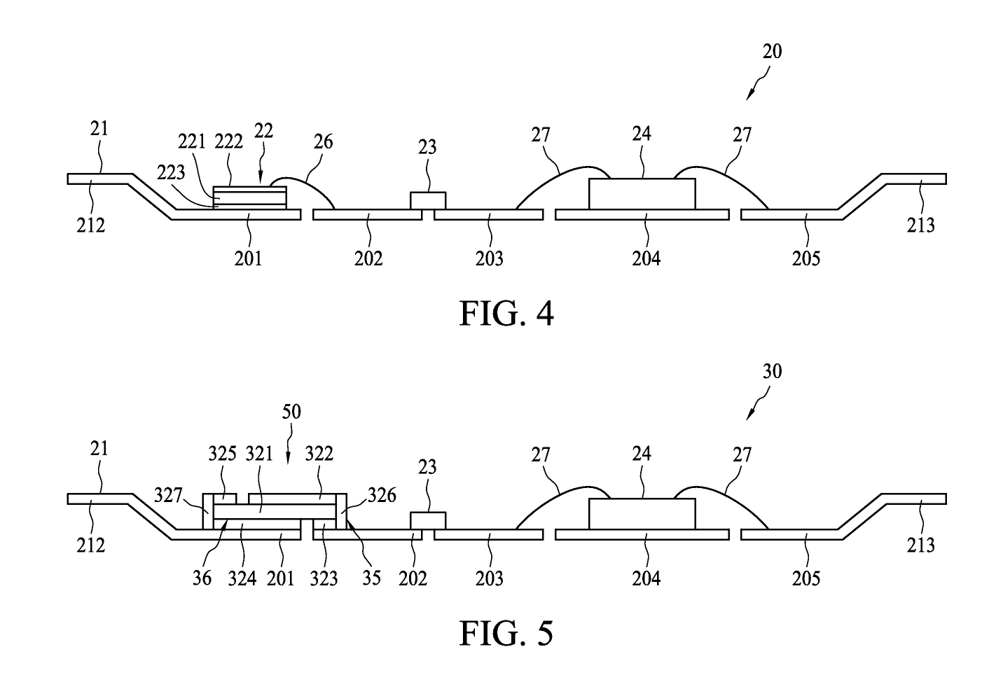

In an embodiment, a top view and a side view of the over-current protection apparatus 20 are shown in FIG. 3 and FIG. 4, respectively. The lead frame 21 comprises blocks 201, 202, 203, 204 and 205 with intervals therebetween. A PTC device 22, a resistor 23, an IC 24 and/or other electronic components may be disposed on the blocks of the lead frame 21. In an embodiment, the PTC device 22 comprises a PTC material layer 221, a first electrode 222 and a second electrode 223, and the first electrode 222 and the second electrode 223 are disposed on the upper and lower surfaces of the PTC material layer 221. The second electrode 223 at the bottom of the PTC device 22 can be directly soldered (surface-mount) onto the leftmost block 201. The first electrode 222 may connect to the block 202 next to the block 201 with a metal wire 26 by wire bonding. In this embodiment, the resistor 23 spans the gap of adjacent blocks 202 and 203. The IC 24 is disposed on the block 204 and may connect to the adjacent blocks 203 and 205 by wire bonding with metal wires 27. Because the lead frame 21 is much thinner than the circuit board of PCM and is able to accommodate the PTC device 22, the resistor 23, the IC 24, the entire height of the over-current protection apparatus 20 can be decreased effectively. For example, the height of the over-current protection apparatus is lower than 1.5 mm or 1.2 mm, or lower than 1 mm.

A PTC device is not restricted to the structure shown in FIG. 4, other types such as surface-mount PTC device can be used also. According to the PTC devices of different structures, the PTC device may connect to the lead frame 21 in different ways. FIG. 5 shows an over-current protection apparatus 30 having a PTC device 50 of a PTC material layer 321, electrode layers 322, 323, 324 and 325. The electrode layers 322 and 325 are disposed on the upper surface of the PTC material layer 321, whereas the electrode layers 323 and 324 are disposed on lower surface of the PTC material layer 321. The electrode layers 322 and 323 are electrically connected by a conductive connecting member 326 to form a first electrode 35. The electrode layers 324 and 325 are electrically connected by a conductive connecting member 327 to form a second electrode 36. In an embodiment, the second electrode 36 and the first electrode 35 are disposed at left and right sides and connect to adjacent blocks 201 and 202, respectively. As a result, there is no need of wire bonding, and the PTC device can be soldered onto the lead frame 21 directly.

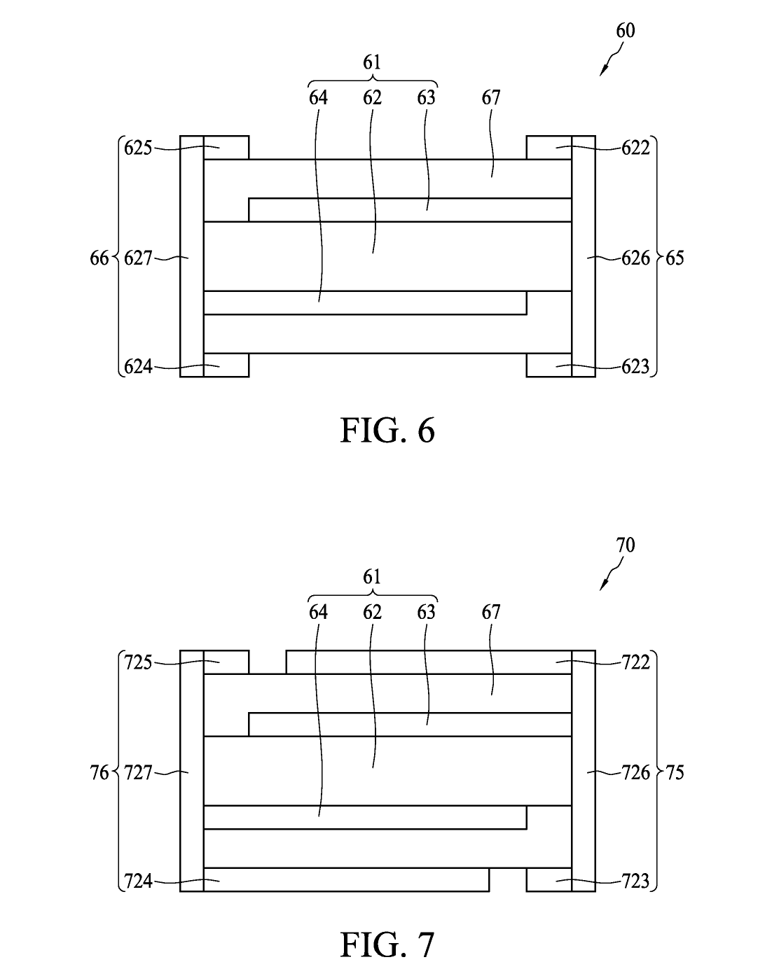

The other PTC devices of left and right electrodes are shown in FIG. 6 and FIG. 7. In FIG. 6, the PTC device 60 comprises a resistive device 61, a first electrode 65 and a second electrode 66. The resistive device 61 comprises a PTC material layer 62, a first conductive layer 63 and a second conductive layer 64. The PTC material layer 62 is laminated between the first conductive layer 63 and the second conductive layer 64 to form a sandwich structure. The first electrode 65 comprises electrode layers 622 and 623, and connects to the first conductive layer 63 through a conductive connecting member 626. The second electrode 66 comprises electrode layers 624 and 625, and connects to the second conductive layer 64 through a conductive connecting member 627. Insulation layers 67 are disposed between the resistive device 61 and the electrode layers 622-625 for isolation. Likewise, the PTC device 60 may span the gap of blocks 201 and 202 of the lead frame 21 by surface mounting, i.e., the electrode layers 624 and 623 connect to neighboring blocks 201 and 202, respectively.

In FIG. 7, the PTC device 70 comprises a resistive device 61, a first electrode 75 and a second electrode 76. The resistive device 61 comprises a PTC material layer 62, a first conductive layer 63 and a second conductive layer 64. The PTC material layer 62 is disposed between the first conductive layer 63 and the second conductive layer 64. The first electrode 75 comprises electrode layers 722 and 723, and connects to the first conductive layer 63 through a conductive connecting member 726. The second electrode 76 comprises electrode layers 724 and 725, and connects to the second conductive layer 64 through a conductive connecting member 727. Insulation layers 67 are disposed between the resistive device 61 and the electrode layers 722-725 for isolation. Compared to the PTC device 60 shown in FIG. 6, the PTC device 70 has elongated electrode layers 722 and 724 so as to provide heat dissipation with higher efficiency. In particular, the electrode layer 722 of the first electrode 75 may occupy over 50% or 67% in area of the upper surface of the PTC device 70, and the electrode layer 724 of the second electrode 76 may occupy over 50% or 67% in area of the lower surface of the PTC device 70, so as to increase heat dissipation efficiency. Likewise, the PTC device 70 may connect to the blocks 201 and 202 of the lead frame 21 by surface mounting, i.e., the electrode layers 724 and 723 connect to the blocks 201 and 202, respectively.

The PTC devices 22 and 50 shown in FIG. 4 and FIG. 5 have a single PTC material layer associated with upper and lower electrodes, and therefore they have advantages in an aspect of low profile. The PTC devices 50, 60 and 70 shown in FIGS. 5, 6 and 7 are of surface-mount type, and can span the gap of adjacent blocks and connect to the blocks with their left and right electrodes. Therefore, the length of the PTC device is not relatively limited, and the PTC device can have large footprint so as to obtain large hold current and low resistance.

The lead frame providing accommodating space decreases the height of the over-current protection apparatus, and can be associated with the PTC device of adequate design to optimize space utilization without sacrificing PTC device size. Not only does effectively decrease the height, but also the over-current protection apparatus can sustain high hold current and low resistance.

The above-described embodiments of the present invention are intended to be illustrative only. Numerous alternative embodiments may be devised by persons skilled in the art without departing from the scope of the following claims.

We claim:

1. An over-current protection apparatus applied to a secondary battery, comprising:
a lead frame having a carrier portion to form an accommodating space, the carrier portion comprising a plurality of blocks;
at least one active or passive device disposed on the carrier portion; and
a PTC device disposed on the carrier portion and comprising a first electrode and a second electrode electrically connecting to different blocks of the carrier portion;
wherein the at least one active or passive device and the PTC device are received in the accommodating space and encapsulated by a cover.

2. The over-current protection apparatus of claim 1, wherein the lead frame further comprises two end portions bending from the carrier portion, and the two end portions electrically connect to positive and negative electrodes of the secondary battery.

3. The over-current protection apparatus of claim 1, wherein the first electrode connects to the lead frame by wire bonding, and the second electrode is soldered onto the lead frame.

4. The over-current protection apparatus of claim 1, wherein the PTC device comprises a PTC material layer, and the first electrode and the second electrode are disposed on upper and lower surfaces of the PTC material layer; the first electrode connects to the lead frame by wire bonding, and the second electrode is soldered onto the lead frame

5. The over-current protection apparatus of claim 1, wherein the PTC device spans a gap of adjacent two blocks of the carrier portion, and the first electrode and the second electrode are soldered onto the adjacent two blocks.

6. The over-current protection apparatus of claim 5, wherein the PTC device further comprises a resistive device having a first conductive layer, a second conductive layer and a PTC material layer laminated therebetween, the first electrode electrically connects to the first conductive layer, and the second electrode electrically connects to the second conductive layer.

7. The over-current protection apparatus of claim 6, wherein the first electrode comprises electrode layers on upper and lower surfaces of PTC device and being connected by a first conductive connecting member, and the second electrode comprises electrode layers on upper and lower surfaces of PTC device and being connected by a second conductive connecting member.

8. The over-current protection apparatus of claim 7, wherein the electrode layer of the first electrode on the upper surface occupies over 50% in area of the upper surface of the PTC device, and the electrode layer of the second electrode on the lower surface occupies over 50% in area of the lower surface of the PTC device.

9. The over-current protection apparatus of claim 1, wherein the over-current protection apparatus has a height less than 1.5 mm.

10. The over-current protection apparatus of claim 1, wherein the active device comprises IC, and the passive device comprises a resistor or a conductor.
